(19) United States
(12) Patent Application Publication
(10) Pub. No.: US 2026/0111378 A1
(43) Pub. Date: Apr. 23, 2026

(54) COMMUNICATION INTERFACE CIRCUIT AND COMMUNICATION METHOD THEREOF

(71) Applicant: SigmaStar Technology Ltd., Xiamen (CN)

(72) Inventor: Yinghua SU, Chengdu (CN)

(21) Appl. No.: 19/330,930

(22) Filed: Sep. 17, 2025

(30) Foreign Application Priority Data
Oct. 17, 2024 (CN) 202411455098.X

(51) Int. Cl. G06F 13/36

(52) U.S. Cl. CPC G06F 13/36; G06F 2213/40

(57) ABSTRACT

A communication interface circuit. Each counting sub-circuit of a master counting circuit records a master counting time required to fully execute a previous requesting command of a corresponding master device. Each slave counting circuit records a slave counting time required to fully execute a previous responding command of a corresponding slave device. A first determination circuit generates a first determination result upon determining that a source master counting circuit has a counting sub-circuit that is in an available state. A second determination circuit generates a second determination result upon determining that an absolute difference between the master counting time recorded by each of the counting sub-circuits in an unavailable state in the source master counting circuit, and a slave counting time recorded by a target slave counting circuit, is not less than a burst length. A control circuit sends a current requesting command to an arbitration circuit for arbitration.

This application claims the benefit of China application Serial No. CN202411455098.X, filed on Oct. 17, 2024, the subject matter of which is incorporated herein by reference.

### BACKGROUND OF THE INVENTION

### Field of the Invention

The present invention relates to a communication interface technique, and more particularly, to a communication interface circuit and a communication method thereof.

### Description of the Related Art

Multiple master devices and multiple slave devices are frequently provided in some electronic systems such as system-on-chips (SoC). These devices need to use a communication interface circuit such as a router for communication with one another, so that commands and data can be transmitted among different devices.

When a master device reads a slave device, it is possible that conflicts among requesting commands sent by the master device occur due to a limited number of channels, such that the slave device may fail to correctly return data to the master device.

### SUMMARY OF THE INVENTION

In view of the issues of the prior art, it is an object of the present invention to provide a communication interface circuit and a communication method thereof so as to improve the prior art.

The present invention includes a communication interface circuit applied to a network system. The network system includes a plurality of master devices and a plurality of slave devices. The communication interface circuit includes: a plurality of master counting circuits, a plurality of slave counting circuits, a control circuit, a first determination circuit and a second determination circuit. Each of the master counting circuits corresponds to a corresponding master device in the master devices, and includes a plurality of counting sub-circuits. Each of the counting sub-circuits records a master counting time required to fully execute a previous requesting command of the corresponding master device. Each of the slave counting circuits corresponds to a corresponding slave device in the plurality of slave devices, and records a slave counting time required to fully execute a previous responding command of the corresponding slave device. The control circuit determines a source master counting circuit and a target slave counting circuit corresponding to a current requesting command received, wherein the source master counting circuit is one of the master counting circuits and the target slave counting circuit is one of the slave counting circuits. The first determination circuit generates a first determination result upon determining that a counting sub-circuit included in the source master counting circuit is in an available state. The second determination circuit generates a second determination result upon determining that an absolute difference between a source master counting time recorded by each of the counting sub-circuits that is in an unavailable state included in the source master counting circuit, and a target slave counting time recorded by the target slave counting circuit, is not less than a burst length. The control circuit sends the current requesting command according to the first determination result and the second determination result to an arbitration circuit to perform arbitration.

The present invention further includes a communication method applied in a communication interface circuit in a network system. The network system includes a plurality of master devices and a plurality of slave devices. The communication method includes: recording, by each of a plurality of master counting circuits that corresponds to a corresponding master device in the master device, and by each counting sub-circuit of a plurality of counting sub-circuits included in each of the master counting circuits, a master counting time required to fully execute a previous requesting command of the corresponding master device; recording, by each of a plurality of slave counting circuits that corresponds to a corresponding slave device in the slave devices, and by each of the slave counting circuits, a slave counting time required to fully execute a previous responding command of the corresponding slave device; determining, by a control circuit, a source master counting circuit and a target slave counting circuit corresponding to a current requesting command received, wherein the source master counting circuit is one of the master counting circuits and the target slave counting circuit is one of the slave counting circuits; generating, by a first determination circuit, a first determination result upon determining that the counting sub-circuits included in the source master counting circuit have a counting sub-circuit that is in an available state; generating, by a second determination circuit, a second determination result upon determining that an absolute difference between the source master counting time recorded by each of the counting sub-circuits that is in an unavailable state included in the source master counting circuit, and a slave counting time recorded by a target slave counting circuit, is not less than a burst length; and sending, by the control circuit, the current requesting command according to the first determination result and the second determination result to an arbitration circuit to perform arbitration.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 shows a block diagram of a network system according to an embodiment of the present invention.

FIG. 2 shows a more detailed block diagram of a communication interface circuit according to an embodiment of the present invention.

FIG. 3 shows an execution timing diagram of a first requesting command and a second requesting command received by a communication interface circuit according to an embodiment of the present invention.

FIG. 4 shows a flowchart of a communication method according to an embodiment of the present invention.

FIG. 5 shows a flowchart of a communication method according to an embodiment of the present invention.

### DETAILED DESCRIPTION OF THE INVENTION

It is an object of the present invention to provide a communication interface circuit and a communication method thereof. The time required to fully execute a previous requesting command by a corresponding master device is recorded by a master counting circuit, and the time required to fully execute a previous requesting command by a corresponding slave device is recorded by a slave counting circuit, so as to determine whether the current requesting command having a burst length is to conflict with the previous requesting command to further determine whether to allow the current requesting command to enter arbitration. Thus, the communication interface circuit significantly reduces the probability of occurrence of conflicts between the current requesting command and the previous requesting command.

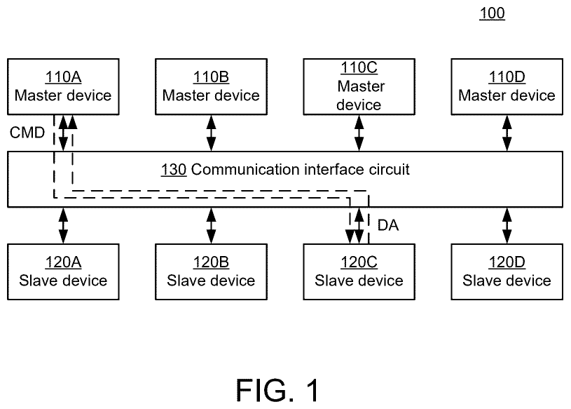

Refer to FIG. 1. FIG. 1 shows a block diagram of a network system 100 according to an embodiment of the present invention. The network system 100 includes a plurality of master devices 110A to 110D, a plurality of slave devices 120A to 120D, and a communication interface circuit 130.

In one embodiment, the network system 100 is a system-on-chip (SoC). Each of the master devices 110A to 110D and the slave devices 120A to 120D is a functional circuit in the SoC, and the communication interface circuit 130 performs communication behaviors including data transmission and requesting command transmission.

Data transmission is to be given as a specific example of the communication behaviors above to describe operations of the communication interface circuit 130. The data transmission is, for example, the master device 110A may transmit a current requesting command CMD, and with arbitration and sending by the communication interface circuit 130, the slave device 120C may receive the current requesting command CMD and accordingly return data DA by the communication interface circuit 130.

Due to a limited number of channels of the communication interface circuit 130, in order to prevent conflicts among multiple requesting commands sent one after another by the multiple master devices 110A to 110D, the communication interface circuit 130 may be provided with a conflict minimizing mechanism to minimize the possibility of conflicts among the requesting commands.

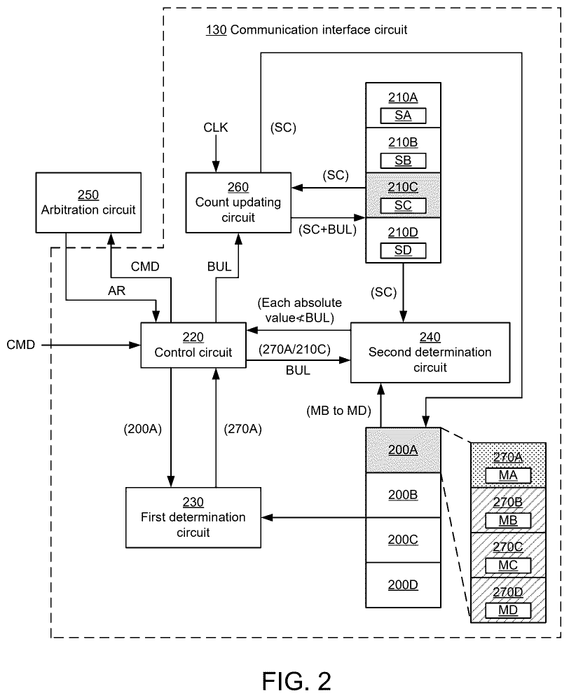

FIG. 2 shows a detailed block diagram of the communication interface circuit 130 according to an embodiment of the present invention. The communication interface circuit 130 includes a plurality of master counting circuits 200A to 200D, a plurality of slave counting circuits 210A to 210D, a control circuit 220, a first determination circuit 230, a second determination circuit 240, an arbitration circuit 250 and a count updating circuit 260.

Each of the circuits in the communication interface circuit 130 may operate according to a clock signal CLK. In FIG. 2, only the clock signal CLK fed to the count updating circuit 260 is depicted for representation.

The master counting circuits 200A to 200D respectively correspond to the master devices 110A and 110D in FIG. 1 in one-on-one correspondence. Each of the master counting circuits 200A and 200D includes a plurality of predetermined number of counting sub-circuits, and each of the counting sub-circuits records a master counting time of a corresponding master device. The predetermined number is a maximum request number of requesting commands that the corresponding master device can send within a time interval, and the time interval is a period from when a first requesting command is sent by the corresponding master device to when a responding command thereof is received. In the example shown in FIG. 2, the master counting circuit 200A includes four counting sub-circuits 270A to 270D to respectively record corresponding master counting times MA to MD, that is, the maximum request number of the master counting circuit 200A is 4.

In one embodiment, each of the master counting times MA to MD is the time required to fully execute a previous requesting command of a corresponding master device. Taking the master counting time MA (which is the time recorded by the counting sub-circuit 270A of the corresponding master device 110A) for example, when the master counting time MA is a non-0 value, it means that the master device 110A has one previous requesting command not yet fully executed, and this requesting command needs the time represented by the value in order to be completed. In an embodiment of the present invention, the time required may be represented by a non-0 value quantized by “data transmission unit time”, and each data transmission unit time is one working cycle of the clock signal CLK. When the master counting time MA is 0, it means that the master device 110A does not have any previous requesting command not yet fully executed.

The slave counting circuits 210A to 210D respectively correspond to the slave devices 120A and 120D in FIG. 1 in one-on-one correspondence. The slave counting circuits 210A to 210D respectively record slave counting times SA to SD of the corresponding slave devices.

In one embodiment, each of the slave counting times SA to SD is the time required to fully execute a previous responding command of a corresponding slave device, and is greater than or equal to a threshold. The responding command is a command from the slave device to return data to the corresponding master device in response to the requesting command received. Taking the slave counting time SA (which is the time recorded by the slave counting circuit 210C of the corresponding slave device 120C) for example, when the slave counting time SC is greater than the threshold, the slave device 120C has a previous responding command not yet fully executed, and this responding command needs the time represented by the slave counting time SC in order to be completed. When the slave counting time SC is the threshold, it means that the slave device 120C does not have any previous responding command not yet fully executed, that is, the slave device 120C does not receive any requesting command or has completed executing all requesting commands received. In one embodiment, the threshold above is a minimum time required for reading one set of data from the corresponding slave device. For example, when the slave device 120A needs at least 8 data transmission unit times to read one set of data, the threshold corresponding to the slave counting time SC is 8. It can be easily understood that, the threshold is associated with the time delay of the network system 100, for example, is a minimum time delay of the network system 100.

The control circuit 220 determines a source master counting circuit, a target slave counting circuit and a burst length corresponding to the current requesting command CMD received by the communication interface circuit 130.

In one embodiment, the current requesting command CMD includes master device information, target slave deice information and a requesting data amount. The control circuit 220 determines, from the master devices 110A to 110D, the source master device corresponding to the current requesting command CMD, and further determines the source master counting circuit corresponding to the source master device. Similarly, the control circuit 220 determines, from the slave devices 120A to 120D, the target slave device corresponding to the current requesting command CMD, and further determines the target slave counting circuit corresponding to the target slave device. For example, when the current requesting command CMD includes information of the master device 110A and the slave device 120C, for example, media access address (MAC), the control circuit 220 accordingly determines the master device 110A as the source master device and the slave device 120C as the target slave device, so as to further determine the master counting circuit 200A as the source master counting circuit and the slave counting circuit 210C as the target slave counting circuit.

The control circuit 220 determines a burst length BUL according to the requesting data amount included in the requesting command CMD. The burst length BUL is a length of time required for sending the data amount requested by the current requesting command CMD from the target slave device. The burst length BUL may also be quantized by “data transmission unit time”, so as to indicate how much time is required for transmitting the data amount requested. It is understandable that, when the data amount requested by each requesting command is the same, the burst length is a constant length of time. Thus, the data amount may be defined in a configuration record of the network system 100, and subsequent requesting commands no longer need to include such data amount.

The first determination circuit 230 is for determining whether the plurality of counting sub-circuits included in the source master counting circuit has a counting sub-circuit that is in an available state. If so, the first determination circuit 230 generates a first determination result.

In one embodiment, the first determination circuit 230 determines that any one of the counting sub-circuits that records the master counting time as a predetermined time such as 0 in source master counting circuit is in an available state, and determines any one of the counting sub-circuits that records the master counting time as a non-predetermined time in the source master counting circuit is in an unavailable state.

In one embodiment, the control circuit 220 may configure the first determination circuit 230 to accordingly determine the states of the counting sub-circuits 270A to 270D when the first determination circuit 230 learns that the source master counting circuit of the current requesting command CMD is the master counting circuit 200A.

For example, when the master counting time MA recorded by the counting sub-circuit 270A is 0 and none of the master counting times MB to MD recorded by the remaining counting sub-circuits 270B to 270D is 0, the first determination circuit 230 determines that the counting sub-circuit 270A is in an available state, and determines that the counting sub-circuits 270B to 270D are each in an unavailable state. At this point, due to the presence of the counting sub-circuit 270A that is in an available state, the first determination circuit 230 generates the first determination result.

The second determination circuit 240 is for determining whether an absolute difference between the source master counting time recorded by each of the counting sub-circuits that is in an unavailable state in the source master counting circuit, and a target slave counting time recorded by the target slave counting circuit, is less than the burst length BUL. If none of the absolute differences is less than the burst length BUL, the second determination circuit 240 generates a second determination result.

In continuation of the example above, the second determination circuit 240 may learn from the control circuit 220 that the source master counting circuit is the master counting circuit 200A, the counting sub-circuits that are in an unavailable state in the master counting circuit 200A are the counting sub-circuits 270B to 270D, and the target slave counting circuit is the slave counting circuit 210C, retrieve the master counting times MB to MD respectively recorded by the counting sub-circuits 270B to 270D and the target slave counting time SC recorded by the target slave counting circuit 210C, and accordingly calculate respective absolute differences, so as to determine whether each of the absolute differences is less than the burst length BUL.

When none of the absolute differences is less than the burst length BUL, it means that the time for returning data requested by the current requesting command CMD does not overlap the time for returning data requested by the previous requesting commands. In other words, for the master device, sending of the current requesting command CMD will not result any conflict with the previous requesting commands that have been sent. The second determination circuit 240 accordingly generates the second determination result.

When any of the absolute differences is less than the burst length BUL, it means that the time for returning data requested by the current requesting command CMD overlaps the time for returning data requested by at least one of the previous requesting commands. In other words, for the master device, sending of the current requesting command CMD will result a conflict with at least one of the previous requesting commands that have been sent, such that the communication interface circuit 130 may be unable to return the data requested by the current requesting command CMD to the master device.

The control circuit 220 sends the current requesting command CMD according to the first determination result generated by the first determination circuit 230 and the second determination result generated by the second determination result 240 to the arbitration circuit 250 to perform arbitration. Details of the arbitration may be referred from existing arbitration techniques, and are omitted herein.

Upon receiving a feedback signal AR that the arbitration circuit 250 returns to indicate a successful arbitration for the current requesting command CMD, the control circuit 220 controls the count updating circuit 260 to update the master counting time recorded by the counting sub-circuit in an available state, such as the counting sub-circuit 270A, to the target slave counting time SC recorded by the target slave counting circuit corresponding to the current requesting command CMD, such as the slave counting circuit 210C. At this point, the counting sub-circuit in an available state enters an unavailable state. As such, the communication interface circuit 130 may learn from the slave counting time (non-0) recorded by the counting sub-circuit when the master device is able to receive the data requested by the current requesting command CMD. In one embodiment, the slave counting time recorded by the counting sub-circuit in an unavailable state is an interval value, the slave counting time SC is a starting point of the interval value, and a sum of the slave counting time SC and the burst length BUL is an ending point of the interval value.

After the feedback signal AR is received, the control circuit 220 further calculates a total of the target slave counting time recorded by the target slave counting circuit and the burst length BUL, and controls the count updating circuit 260 to update the target slave counting time recorded by the target slave counting circuit to the counted total to indicate that when (after the slave counting time) the slave device corresponding to the slave counting circuit is able to respond to another new request.

Moreover, on the basis of each data transmission unit time (for example, according to each cycle of the clock signal CLK), the count updating circuit 260 may decreasingly update the master counting time recorded by each of the counting sub-circuits that is in an unavailable state and each of the slave counting times recorded by each of the slave counting circuits. For example, the value of each of the master counting times and the slave counting times is updated by decreasing by 1 according to each data transmission unit.

In one embodiment, taking the slave counting time SA of the slave counting circuit 210A for example, the count updating circuit 260 stops updating the slave counting time SA recorded by the slave counting circuit 210A when the slave counting time SA recorded by the slave counting circuit 210A is equal to the threshold. At this point, the slave counting circuit 210 returns to an initial state.

In one embodiment, when the first determination circuit 230 determines that the master counting circuit corresponding to the current requesting command CMD does not have any counting sub-circuit that is in an available state, or when the second determination circuit 240 determines that the absolute difference between the source master counting time of at least one counting sub-circuit that is in unavailable state in the corresponding master counting circuit and the target slave counting time of the target slave counting circuit is less than the burst length BUL, the control circuit 220 does not send the current requesting command CMD to the arbitration circuit 250 and no arbitration is performed.

At this point, according to different hardware designs, the current requesting command CMD may be selectively temporarily stored in the source master device such as the master device 110A, or temporarily stored in a buffer circuit (not shown) of the communication interface circuit 130. Only when the first determination circuit 230 determines that the master counting circuit has a counting sub-circuit that is in an available state and when the second determination circuit 240 determines that the absolute difference between the master counting time of each of the counting sub-circuits that is in an unavailable state in the source master counting circuit and the target slave counting time of the target slave counting circuit is not less than the burst length BUL, the current requesting command CMD is sent to the arbitration circuit 250 to perform arbitration.

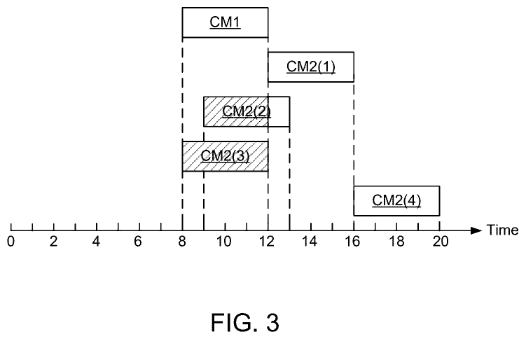

Refer to FIG. 3. FIG. 3 shows an execution timing diagram of a first requesting command CM1 and a second requesting command CM2 received by the communication interface circuit 130 according to an embodiment of the present invention. The first requesting command CM1 is sent by the master device 110A to request to read data having a data amount of four units from the slave device 120A, and the second requesting command CM2 is sent by the master device 110A to also request to read data having a data amount of four units from a slave device.

In this example, assume that the slave device 120A in an initial state does not have any requesting command that is not yet fully executed. At this point, the slave counting time SA recorded by the slave counting circuit 210A corresponding to the slave device 120A is the threshold, for example, 8.

When the communication interface circuit 130 receives the first requesting command CM1 sent by the master device 110A, the first determination circuit 230 determines that the master counting circuit 200A corresponding to the master device 110A has a counting sub-circuit that is in an available state, for example, the counting sub-circuit 270A, and the second determination circuit 240 determines that an absolute difference between the master counting time recorded by the counting sub-circuit that is in an unavailable state in the master counting circuit 200A and the slave counting time SA is not less than the burst length BUL, the control circuit 220 sends the first requesting command CM1 to the arbitration circuit 250 to perform arbitration.

Upon receiving the feedback signal AR that the arbitration circuit 250 returns to indicate a successful arbitration for the first requesting command CM1, the control circuit 220 controls the count updating circuit 260 to update the master counting time MA recorded by the counting sub-circuit 270A to the slave counting time SA (which is 8) recorded by the slave counting circuit 210A, and calculates the total of this slave counting time SA and the burst length BUL (which is 4), so as to update the slave counting time SA recorded by the slave counting circuit 210A to this total. At this point, the master counting time MA recorded by the counting sub-circuit 270A is 8, the slave counting time SA1 recorded by the slave counting circuit 210A is 12, and the counting sub-circuit 270A is in an unavailable state. Further, the control circuit 220 determines that an execution time window of the first requesting command CM1 is [8, 12] according to the burst length BUL, and thus updates the master counting time MA recorded by the counting sub-circuit 270A to the interval value [8, 12].

When the communication interface circuit 130 receives the second requesting command CM2 sent by the master device 110A to read data from a slave device and the burst length BUL of the second requesting command CM2 is still 4, the first determination circuit 220 determines that the master counting circuit 200A still has a counting sub-circuit that is in an available state, for example, the counting sub-circuit 270B. The second determination circuit 240 further determines whether an absolute difference between the master counting time (for example, the master counting time MA recorded by the counting sub-circuit 270A) of the counting sub-circuit that is in an unavailable state in the master counting circuit 200A and the slave counting time is not less than the burst length BUL. Several possible application scenarios of the second requesting command CM2 are described below.

In the first application scenario, assume that the target slave device of the second requesting command (indicated as the second requesting command CM2(1) in FIG. 3) is still the slave device 120A. The second determination circuit 240 determines that the absolute difference |8−12|=4 between the master counting time MA recorded by the counting sub-circuit 270A that is in an unavailable state and the slave counting time SA recorded by the slave counting circuit 210A is not less than the burst length BUL which is 4. At this point, the control circuit 220 sends the second requesting command CM2 to the arbitration circuit 250 to perform arbitration.

Upon receiving the feedback signal AR that the arbitration circuit 250 returns to indicate a successful arbitration for the second requesting command CM2, the control circuit 220 controls the count updating circuit 260 to update the master counting time MB recorded by the counting sub-circuit 270B to the slave counting time SA, and calculates the total of the slave counting time SA and the burst length BUL (which is 4), so as to update the slave counting time SA recorded by the slave counting circuit 210A to this total. Thus, the master counting time MB recorded by the counting sub-circuit 270B is 12, the slave counting time SA recorded by the slave counting circuit 210A is 12+4=16, and the counting sub-circuit 270B is in an unavailable state. Further, the control circuit 220 determines that an execution time window of the second requesting command CM2 is [12, 16] according to the burst length BUL, and thus updates the master counting time MB recorded by the counting sub-circuit 270B to the interval value [12, 16].

In the second application scenario, assume that the target slave device of the second requesting command CM2 (indicated as the second requesting command CM2(2) in FIG. 3) is the slave device 120B, and the slave counting time SB recorded by the corresponding slave counting circuit 210B is 9. The second determination circuit 240 determines that the absolute difference |8−9|=1 between the master counting time MA recorded by the counting sub-circuit 270A that is in an unavailable state and the slave counting time SB is less than the burst length BUL which is 4. The control circuit 220 accordingly determines that the second requesting command CM2 will conflict with the first requesting command CM1 (as the three data transmission unit times indicated by slash lines in the drawing). The control circuit 220 does not send the second requesting command CM2 to the arbitration circuit 250, and no corresponding arbitration is performed.

In the third application scenario, assume that the target slave device of the second requesting command CM2 (indicated as the second requesting command CM2(3) in FIG. 3) is the slave device 120C, and the slave counting time SC recorded by the corresponding slave counting circuit 210C is 8. The second determination circuit 240 determines that the absolute difference |8−8|=0 between the master counting time MA recorded by the counting sub-circuit 270A that is in an unavailable state and the slave counting time SC is less than the burst length BUL which is 4. The control circuit 220 accordingly determines that the second requesting command CM2 will conflict with the first requesting command CM1 (as the four data transmission unit times indicated by slash lines in the drawing). The control circuit 220 does not send the second requesting command CM2 to the arbitration circuit 250, and no corresponding arbitration is performed.

In the fourth application scenario, assume that the target slave device of the second requesting command CM2 (indicated as the second requesting command CM2(4) in FIG. 3) is the slave device 120D, and the slave counting time SD recorded by the corresponding slave counting circuit 210D is 16. The second determination circuit 240 determines that the absolute difference |8−16|=8 between the master counting time MA recorded by the counting sub-circuit 270A that is in an unavailable state and the slave counting time SD is not less than the burst length BUL which is 4. At this point, the control circuit 220 determines that the second requesting command CM2 will not conflict with the first requesting command CM1, and sends the second requesting command CM2 to the arbitration circuit 250 to perform arbitration.

Upon receiving the feedback signal AR that the arbitration circuit 250 returns to indicate a successful arbitration for the second requesting command CM2, the control circuit 220 controls the count updating circuit 260 to update the master counting time MB recorded by the counting sub-circuit 270B to the slave counting time SD, and calculates the total of the slave counting time SD and the burst length BUL (which is 4), so as to update the slave counting time SD recorded by the slave counting circuit 210D to this total. Thus, the master counting time MB recorded by the counting sub-circuit 270B is 16, the slave counting time SD recorded by the slave counting circuit 210D is 16+4=20, and the counting sub-circuit 270B is in an unavailable state. Further, the control circuit 220 determines that the execution time window of the second requesting command CM2 is [16, 20] according to the burst length BUL, and thus updates the master counting time MB recorded by the counting sub-circuit 270B to the interval value [16, 20].

It is understandable that, when the master counting time recorded by the counting sub-circuit is an interval value, the control circuit 220 in default selects a minimum value of the interval value upon determining the absolute value between the master counting time recorded by the counting sub-circuit that is in an unavailable state and the slave counting time.

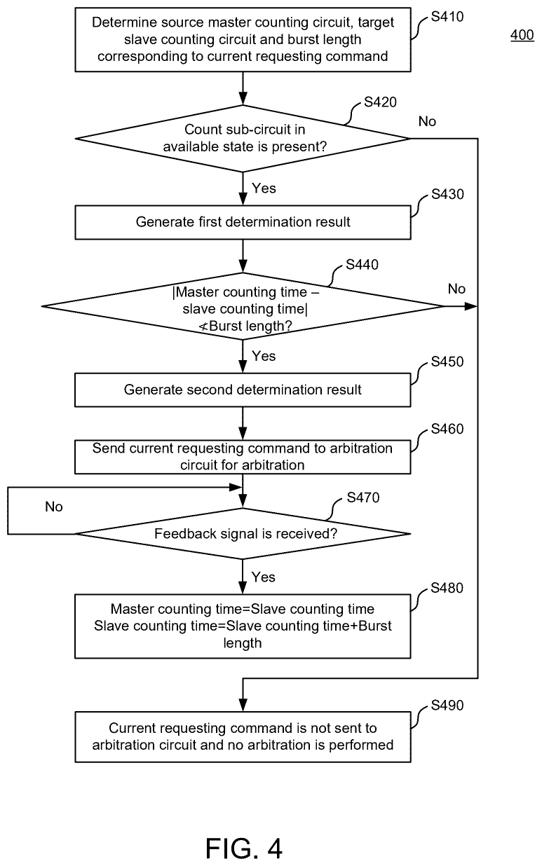

Refer to FIG. 4 showing a flowchart of a communication method 400 according to an embodiment of the present invention. The communication method 400 may be applied to the communication interface circuit 130, and includes the following steps.

In step S410, the control circuit 220 determines a source master counting circuit and a target slave counting circuit corresponding to the current requesting command CMD received.

In step S420, the first determination circuit 230 determines whether the counting sub-circuits of the source master counting circuit have a counting sub-circuit that is in an available state. If so, step S430 is entered; if not, step S490 is entered.

In step S430, the first determination circuit 230 generates a first determination result upon determining that the counting sub-circuits of the source master counting circuit have a counting sub-circuit that is in an available state.

In step S440, the second determination circuit 240 determines whether an absolute difference between the source master counting time recorded by each of the counting sub-circuits that is in an unavailable state in the source master counting circuit, and a slave counting time recorded by the target slave counting circuit, is less than the burst length BUL. If so, step S450 is entered; if not, step S490 is entered.

In step S450, the second determination circuit 240 generates a second determination result.

In step S460, the control circuit 220 sends the current requesting command CMD according to the first determination result and the second determination result to the arbitration circuit 250 to perform arbitration.

In step S470, the control circuit 220 determines whether the feedback signal AR that the arbitration circuit 250 returns for the current requesting command CMD is received. If so, step S480 is entered; if not, step S470 is entered.

In step S480, the count updating circuit 260 updates the master counting time MA recorded by the counting sub-circuit that is in the available state such as the counting sub-circuit 270A to the slave counting time SC recorded by the target slave counting circuit such as the slave counting circuit 210C. Moreover, the count updating circuit 260 calculates a total of the target slave counting time SC and the burst length BUL, so as to update the slave counting time SC recorded by the target slave counting circuit 210C to this total.

In step S490, when the first determination circuit 230 determines in step S430 that the counting sub-circuits in the source master counting circuit does not have any counting sub-circuit that is in an available state, or when the second determination circuit 240 determines in step S440 that the absolute difference between the master counting time of any of the counting sub-circuits that is in an unavailable state and the slave counting time of the target slave counting circuit is less than the burst length BUL, the control circuit 220 does not send the current requesting command CMD to the arbitration circuit 250 and no arbitration is performed.

In addition to performing determination and determining whether to perform arbitration for the current requesting command CMD above, the communication interface circuit 130 may also continually perform operations of updating the master counting time and the slave counting time on the basis of each data transmission unit time.

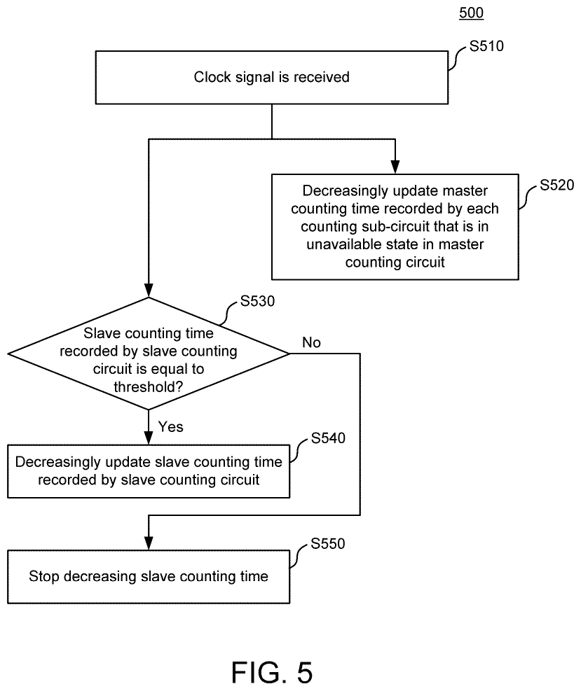

Refer to FIG. 5. FIG. 5 shows a flowchart of a communication method 500 according to an embodiment of the present invention. The communication method 500 describes that the communication interface circuit 130 updates the values of the master counting time recorded by the counting sub-circuit in an unavailable state and the slave counting time recorded by each slave counting circuit corresponding to each data transmission unit time. In this embodiment, the following steps of the communication method 500 are performed by the count updating circuit 260.

In step S510, a clock signal is received.

In step S520, the master counting time recorded by each of the counting sub-circuits that is in an unavailable state is decreasingly updated.

In step S550, it is determined whether the slave counting time recorded by the slave counting circuit is equal to a threshold. If not, step S540 is entered; if so, step S550 is entered.

In step S540, the slave counting time recorded by the slave counting circuit is decreasingly updated.

In step S550, the decreasing of the slave counting time is stopped.

It is understandable that, step S520 and steps S530 to S550 may be performed simultaneously.

In conclusion, in the communication interface circuit and the communication method thereof, the time required to fully execute a previous requesting command by a corresponding master device is recorded by a master counting circuit, and the time required to fully execute a previous requesting command by a corresponding slave device is recorded by a slave counting circuit, so as to determine whether the current requesting command is to conflict with the previous requesting command to further determine whether to allow the current requesting command to enter arbitration. Thus, the communication interface circuit significantly reduces the probability of occurrence of conflicts between the current requesting command and the previous requesting command.

While the present application has been described by way of example and in terms of the preferred embodiments, it is to be understood that the disclosure is not limited thereto. Various modifications made be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. A communication interface circuit, applied to a network system, the network system comprises a plurality of master devices and a plurality of slave devices; the communication interface circuit comprising:
a plurality of master counting circuits, each corresponding to a corresponding master device in the plurality of master devices, and each of the plurality of master counting circuits comprising a plurality of counting sub-circuits, each of the plurality of counting sub-circuits recording a master counting time required to fully execute a previous requesting command of the corresponding master device;
a plurality of slave counting circuits, each corresponding to a corresponding slave device in the plurality of slave devices, and recording a slave counting time required to fully execute a previous responding command of the corresponding slave device;
a control circuit, determining a source master counting circuit and a target slave counting circuit corresponding to a current requesting command received, wherein the source master counting circuit is one of the plurality of master counting circuits and the target slave counting circuit is one of the plurality of slave counting circuits;
a first determination circuit, generating a first determination result upon determining that one of the plurality of counting sub-circuits included in the source master counting circuit is in an available state; and
a second determination circuit, generating a second determination result upon determining that an absolute difference between a source master counting time recorded by each of the plurality of counting sub-circuits that is in an unavailable state in the source master counting circuit, and a target slave counting time recorded by the target slave counting circuit, is not less than a burst length;
wherein the control circuit sends the current requesting command according to the first determination result and the second determination result to an arbitration circuit to perform arbitration.

2. The communication interface circuit according to claim 1, further comprising:
a count updating circuit, updating the source master counting time recorded by the counting sub-circuit that is in the available state to the target slave counting time, and calculating a total of the target slave counting time and the burst length so as to update the target slave counting time recorded by the target slave counting circuit to the total.

3. The communication interface circuit according to claim 2, wherein the count updating circuit decreasingly updates the master counting time recorded by each of the counting sub-circuits that is in an unavailable state in the master counting circuits and the slave counting time recorded by each of the slave counting circuits according to a clock signal.

4. The communication interface circuit according to claim 3, wherein the count updating circuit stops decreasing the slave counting time recorded by the slave counting circuit that returns to an initial state when one of the slave counting times recorded by the slave counting circuits is equal to a threshold, the slave counting time of the slave counting circuit that returns to the initial state is equal to the threshold, and the threshold is associated with a time delay of the network communication system.

5. The communication interface circuit according to claim 1, wherein the requesting command comprises source master device information, target slave device information and a request data amount, and the control circuit determines the source master counting circuit according to the source master device information, determines the target slave counting circuit according to the target slave device information and determines the burst length according to the request data amount.

6. The communication interface circuit according to claim 1, wherein the first determination circuit determines that one of the plurality of counting sub-circuits included in the source master counting circuit is in the available state when one of source master counting times recorded by the plurality of counting sub-circuits included in the source master counting circuit comprise a predetermined time, and the source master counting time recorded by the counting sub-circuit that is in the available state is the predetermined time.

7. The communication interface circuit according to claim 1, wherein when the first determination circuit determines that the counting sub-circuit that is in the available state is absent or when the second determination circuit determines that an absolute difference between the source master counting time of one of the plurality of counting sub-circuits that is in the unavailable state and the target slave counting time is less than the burst length, the control circuit does not send the current requesting command to the arbitration circuit and no arbitration is performed.

8. The communication interface circuit according to claim 1, wherein each of the plurality of master counting circuits comprises a predetermined number of counting sub-circuits, and the predetermined number is a maximum request number of requesting commands that the corresponding master device is able to send within a period of time from when a first requesting command is sent to when a responding command thereof is received.

9. A communication method, applied to a communication interface circuit in a network system, the network system comprises a plurality of master devices and a plurality of slave devices; the communication method comprising:
corresponding each of a plurality of master counting circuits to a corresponding master device in the plurality of master devices, and recording by each counting sub-circuit in a plurality of counting sub-circuits included in each of the plurality of master counting circuits, a master counting time required to fully execute a previous requesting command of the corresponding master device;
corresponding each of a plurality of slave counting circuits to a corresponding slave device in the plurality of slave devices, and recording, by each of the plurality of slave counting circuits, a slave counting time required to fully execute a previous responding command of the corresponding slave device;
determining, by a control circuit, a source master counting circuit and a target slave counting circuit corresponding to a current requesting command received, wherein the source master counting circuit is one of the plurality of master counting circuits and the target slave counting circuit is one of the plurality of slave counting circuits;
generating, by a first determination circuit, a first determination result upon determining that one of the plurality of counting sub-circuits included in the source master counting circuit is in an available state;
generating, by a second determination circuit, a second determination result upon determining that an absolute difference between a source master counting time recorded by each of the plurality of counting sub-circuits that is in an unavailable state included in the source master counting circuit, and a target slave counting time recorded by the target slave counting circuit, is not less than a burst length; and
sending, by the control circuit, the current requesting command according to the first determination result and the second determination result to an arbitration circuit to perform arbitration.

10. The communication method according to claim 9, further comprising:
updating, by a count updating circuit, the source master counting time recorded by the counting sub-circuit that is in the available state to the target slave counting time, and calculating a total of the target slave counting time and the burst length to update the target slave counting time recorded by the target slave counting circuit to the total.
